(19) United States
(12) Patent Application Publication
(10) Pub. No.: US 2012/0093116 A1
(43) Pub. Date: Apr. 19, 2012

(54) METHOD FOR ALLOCATING HARQ FEEDBACK CHANNEL IN GROUP RESOURCE ALLOCATION

(76) Inventors: Jeong Ki Kim, Gyeonggi-do (KR); Young Soo Yuk, Gyeonggi-do (KR)

(21) Appl. No.: 13/378,279

(22) PCT Filed: Jun. 25, 2010
(86) PCT No.: PCT/KR2010/004163

§ 371 Date: Dec. 14, 2011

Related U.S. Application Data
(60) Provisional application No. 61/220,203, filed on Jun. 25, 2009.
(60) Provisional application No. 61/220,568, filed on Jun. 25, 2009.

(30) Foreign Application Priority Data
Jun. 25, 2010 (KR) 1020100060405

(51) Int. Cl. H04W 72/04

(52) U.S. Cl. 370/329

(57) ABSTRACT

The present system relates to a group resource allocation method for use in a wireless communication system, and methods and apparatus for allocating HARQ feedback allocation (HFA) channel in group resource allocation are disclosed. One embodiment of the present invention comprises the steps of receiving a group resource allocation A-MAP information element (GRA A-MAP IE) that includes an HFA offset field for indicating the start of an HFA channel used for terminals that are scheduled and deleted from a base station, a number field for denoting the number of deleted terminals NDA and a user bitmap field for indicating a scheduled terminal, and transmitting and receiving an acknowledgement message through the HARQ feedback channel that is acquired by using the HFA offset field, the number field and the user bitmap field.

### TECHNICAL FIELD

The present invention relates to a method for allocating group resources used in a wireless access system.

### BACKGROUND ART

A group resource allocation (GRA) method is to allocate resources to several users (i.e., user equipments) belonging to one group, so as to reduce overhead of a control message transmitted from a base station to a user equipment. If the GRA method is used, since the base station may transmit control information compressed in a group unit to the user equipments when separately allocating resources to the user equipments, signaling overhead within a network may be reduced.

The base station may use group control information to allocate and configure resources to one or more user equipments belonging to one group. Here, the group control information may be referred to as advanced MAP or A-MAP. For user specific control information for a single user or user group, multiple information elements are separately coded for the A-MAP. Also, the A-MAP is transmitted by CRC masking with ID (for example, STID of a specific user equipment, broadcast STID and/or multicast STID) of the user equipment.

Since the A-MAP is transmitted by separate encoding and masking with STID, the user equipment performs blind decoding for a region to which the A-MAP is transmitted, to identify whether there is any A-MAP transmitted thereto. Here, the user equipment may detect the A-MAP by using STID allocated thereto, broadcast STID and/or multicast STID (for example, group ID, persistent ID, sleep/idle mode ID or MBS ID).

The user equipment performs blind decoding on the basis of MAP size used in the corresponding system. Here, the base station and/or the user equipment may restrict the size and type of the MAP to specific sizes and types to reduce the number of times for blind decoding. For example, the base station and/or the user equipment may restrict the size of the A-MAP information element (IE) to either three sizes such as 56 (or 64), 96 and 144, or two sizes such as 56 (or 64) and 96.

It is assumed that one minimum A-MAP logical resource unit (MLRU) includes 48 data subcarriers, two MLRUs include 96 data subcarriers, and the size of the A-MAP IE is determined to 56 or 96. Here, the base station may map 56 bit A-MAP IE into 1 MLRU and 96 bit A-MAP IE into 2 MLRUs by using an encoding method (for example, tail-biting convolutional code (TBCC) or puncturing scheme) for a downlink control channel, and may transmit the mapped data to the user equipment.

### DISCLOSURE

### Technical Problem

One or more groups may exist in a cell managed by a base station. Also, one group may include one or more user equipments having similar features. However, enter and exit of the user equipment may occur in the corresponding group, and an HARQ feedback channel is allocated to a user equipment deleted from the corresponding group, whereby HAF overhead may be increased.

The present invention has been devised to solve the conventional problems as above, and an object of the present invention is to provide a method for allocating an efficient HARQ ACK channel.

Another object of the present invention is to provide a method for reducing HFA overhead of user equipments deleted from A-MAP for resource allocation.

Other object of the present invention is to provide a user equipment and a base station, which support the aforementioned methods.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

To solve the aforementioned technical problems, methods and apparatuses for newly defining a GRA A-MAP IE for group resource allocation and efficiently allocating an HARQ feedback channel to scheduled user equipments and deleted user equipments are disclosed.

In one embodiment of the present invention, a method for allocating an HARQ feedback allocation (HFA) channel in group resource allocation comprises the steps of receiving a group resource allocation A-MAP information element (GRA A-MAP IE) from a base station, the group resource allocation A-MAP information element including an HFA offset field for indicating the start of the HFA channel used for user equipments that are scheduled and deleted, a number (NDA) field for denoting the number of the deleted user equipments, and a user bitmap field for indicating the scheduled user equipments; and transmitting and receiving an acknowledgement message through the HARQ feedback channel that is acquired by using the HFA offset field, the number field and the user bitmap field.

In another embodiment of the present invention, a method for allocating an HARQ feedback allocation (HFA) channel in group resource allocation comprises the steps of transmitting a group resource allocation A-MAP information element (GRA A-MAP IE) at a base station, the group resource allocation A-MAP information element including an HFA offset field for indicating the start of the HFA channel used for user equipments that are scheduled and deleted, a number (NDA) field for denoting the number of the deleted user equipments, and a user bitmap field for indicating the scheduled user equipments; and transmitting and receiving an acknowledgement message through the HARQ feedback channel indicated by the HFA offset field, the number field and the user bitmap field.

In still another embodiment of the present invention, a user equipment allocated with an HARQ feedback allocation (HFA) channel in group resource allocation comprises a transmission (Tx) module for transmitting a radio signal; a reception (Rx) module for receiving the radio signal; and a processor supporting functions related to the group resource allocation. In this case, the user equipment receives a group resource allocation A-MAP information element (GRA A-MAP IE) from a base station, the group resource allocation A-MAP information element including an HFA offset field for indicating the start of the HFA channel used for user equipments that are scheduled and deleted, a number (NDA) field for denoting the number of the deleted user equipments, and a user bitmap field for indicating the scheduled user equipments, the processor of the user equipment acquires the HARQ feedback channel for group resource allocation to which the user equipment belongs, by using the HFA offset field, the number field and the user bitmap field, and the user equipment transmits an acknowledgment message to the base station by using the Tx module.

In further still another embodiment of the present invention, a base station allocating an HARQ feedback allocation (HFA) channel in group resource allocation comprises a transmission (Tx) module for transmitting a radio signal; a reception (Rx) module for receiving the radio signal; and a processor supporting functions related to the group resource allocation. In this case, the base station transmits a group resource allocation A-MAP information element (GRA A-MAP IE) through the Tx module, the group resource allocation A-MAP information element including an HFA offset field for indicating the start of the HFA channel used for user equipments that are scheduled and deleted, a number (NDA) field for denoting the number of the deleted user equipments, and a user bitmap field for indicating the scheduled user equipments. Also, the base station may receive an acknowledgement message through the HARQ feedback channel indicated by the HFA offset field, the number field and the user bitmap field through the Tx module.

In the embodiments of the present invention, the group resource allocation A-MAP information element may further include a user bitmap index field indicating a user bitmap index for each of the deleted user equipments. In another aspect, the group resource allocation A-MAP information element may further include a deletion bitmap field indicating the deleted user equipments.

In the embodiments of the present invention, the HARQ feedback channel may be allocated in the order of the acknowledgement channel indicated by the HFA offset field, the acknowledgement channel for the deleted user equipments, and the acknowledgement channel for the scheduled user equipments.

The aforementioned embodiments of the present invention are only a part of the preferred embodiments of the present invention, and various embodiments in which technical features of the present invention are reflected may be devised and understood based on the detailed description of the present invention, which will be described later, by the person with ordinary skill in the art.

### Advantageous Effects

According to the embodiments of the present invention, the following advantages may be obtained.

First of all, the base station and the user equipment may efficiently allocate and acquire an HARQ ACK channel by using the embodiments of the present invention.

Second, HFA overhead of user equipments deleted from GRA A-MAP for resource allocation may be reduced effectively by using an HFA offset field, an NDA field, a user bitmap index field and/or a deletion bitmap field.

Third, HFA channels for user equipments in group resource allocation may sequentially be allocated to each scheduled user equipment group or each deleted user equipment group. Also, the deleted user equipments and the scheduled user equipments may reduce unnecessary map overhead by sharing HFA offset together.

Finally, the base station and the user equipment may use efficiently radio resources of a network by removing an unnecessary HFA channel in an uplink through the deletion bitmap field.

It will be appreciated by persons skilled in the art that that the effects that could be achieved with the present invention are not limited to what has been particularly described hereinabove and other advantages of the present invention will be more clearly understood from the following detailed description. In other words, advantages or effects not intended by the present invention may be devised from the embodiments of the present invention by the person with ordinary skill in the art.

### BRIEF DESCRIPTION OF THE DRAWINGS

FIG. 1 is a diagram illustrating an example of a group resource allocation method based on a bitmap;

FIG. 2 is a diagram illustrating an example of a group resource allocation method;

FIG. 3 is a diagram illustrating an example of an HARQ feedback channel allocated to user equipments deleted from a group;

FIG. 4 is a diagram illustrating a mapping relation between a user bitmap based on A-MAP IE field of Table 2 and an HARQ feedback channel;

FIG. 5 is a diagram illustrating a method of using a deletion bitmap;

FIG. 6 is a diagram illustrating a method for allocating an uplink ACK channel and a downlink ACK channel by using a deletion bitmap;

FIG. 7 is a diagram illustrating an example of a method for allocating downlink group resources based on a deletion bitmap in accordance with one embodiment of the present invention;

FIG. 8 is a diagram illustrating an example of a method for allocating uplink group resources based on a deletion bitmap in accordance with another embodiment of the present invention; and

FIG. 9 is a diagram illustrating a user equipment and a base station through which the embodiments of the present invention described in FIG. 1 to FIG. 8 can be carried out, in accordance with another embodiment of the present invention.

### BEST MODE FOR CARRYING OUT THE INVENTION

The embodiments of the present invention disclose group resource allocation methods used in a wireless access system. In particular, the embodiments of the present invention disclose methods and apparatuses for newly defining a GRA A-MAP IE for group resource allocation and efficiently allocating an HARQ feedback channel to scheduled user equipments and deleted user equipments.

The following embodiments are achieved by combination of components and features of the present invention in a predetermined type. Each of the components or features should be considered selectively unless specified separately. Each of the components or features may be carried out without being combined with other components or features. Also, some components and/or features may be combined with one another to constitute the embodiments of the present invention. The order of operations described in the embodiments of the present invention may be changed. Some components or features of one embodiment may be included in another embodiment, or may be replaced with corresponding components or features of another embodiment.

In the description of drawings, procedures or steps that may make the subject matter of the present invention obscure will not be disclosed. Also, procedures or steps that may be understood by the person with ordinary skill in the art will not be disclosed.

In this specification, the embodiments of the present invention have been described based on the data transmission and reception between a base station and a mobile station. In this case, the base station means a terminal node of a network, which performs direct communication with the mobile station. A specific operation which has been described as being performed by the base station may be performed by an upper node of the base station as the case may be.

In other words, it will be apparent that various operations performed for communication with the mobile station in the network which includes a plurality of network nodes along with the base station may be performed by the base station or network nodes other than the base station. Here, the base station (BS) may be replaced with terms such as a fixed station, Node B, eNode B (eNB), and an access point (AP).

Also, the mobile station may be replaced with terms such as a user equipment (UE), a subscriber station (SS), a mobile subscriber station (MSS), a mobile terminal (MT), an advanced mobile station (AMS) and a terminal.

Furthermore, a transmitting side means a fixed and/or mobile node that provides data services or voice services while a receiving side means a fixed and/or mobile node that receives data services or voice services. Accordingly, in an uplink, the mobile station could be a transmitting side while the base station could be a receiving side. Likewise, in a downlink, the mobile station could be a receiving side while the base station could be a transmitting side.

The embodiments of the present invention can be supported by standard documents disclosed in at least one of wireless access systems, i.e., IEEE 802.xx system, 3GPP system, 3GPP LTE system, and 3GPP2 system. Namely, among the embodiments of the present invention, apparent steps or parts which are not described may be described with reference to the above documents.

Also, all terminologies disclosed herein can be described by the above standard documents. Particularly, the embodiments of the present invention can be supported by one or more of standard documents of IEEE 802.16 system, i.e., P802.16e-2004, P802.16e-2005, P802.16Rev2, and P802.16m.

Hereinafter, the preferred embodiments of the present invention will be described with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out.

Also, specific terminologies hereinafter used in the embodiments of the present invention are provided to assist understanding of the present invention, and various modifications can be made in the specific terminologies within the range that they do not depart from technical spirits of the present invention.

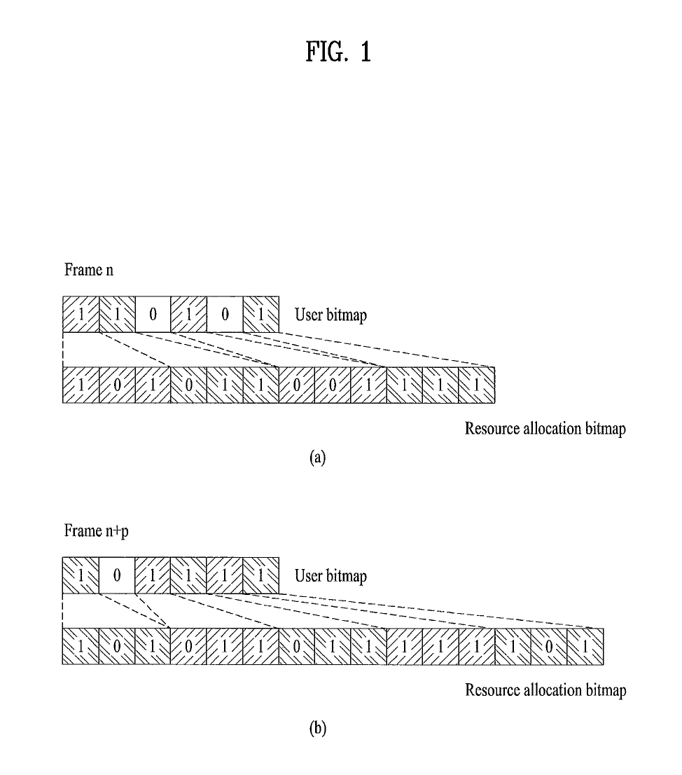

FIG. 1 is a diagram illustrating an example of a group resource allocation method based on a bitmap.

In order to notify user equipments belonging to a predetermined group of resource allocation information, bitmaps may be used. Referring to FIG. 1, a user bitmap which is the first bitmap represents what user equipment is scheduled from the corresponding group at the corresponding time. Each bit of the user bitmap corresponds one-to-one to the user equipments belonging to the group. Here, one group may include up to six users, and if each bit of the bitmap is set to ‘1’, it indicates that the corresponding user equipment is the user (that is, user allocated with resources) scheduled at a current frame.

Referring to FIG. 1, it is noted that first, second, fourth and sixth users are scheduled at a frame ‘n’ and the other user equipments except for the second user equipment are scheduled at a frame ‘n+p’. Here, each user equipment may acquire location information indicating its location within a user bitmap from the base station when it is added to the group. A resource allocation bitmap represents resource allocation information of scheduled users, wherein the resource allocation information may include a modulation and coding scheme (MCS) and information on size of allocated resource.

In FIG. 1, information on one user equipment may be represented by 3 bits, and since a total of four user equipments are scheduled at the nth frame (Frame n), the size of the resource allocation bitmap becomes 12 bits (3×4). Since a total of five user equipments are scheduled at the (n+p)th frame (Frame n+p), 15-bit sized resource allocation bitmap is formed. Here, the resource allocation bitmap includes MCS information of the scheduled user equipment and allocated resource allocation size information (for example, the number of LRUs).

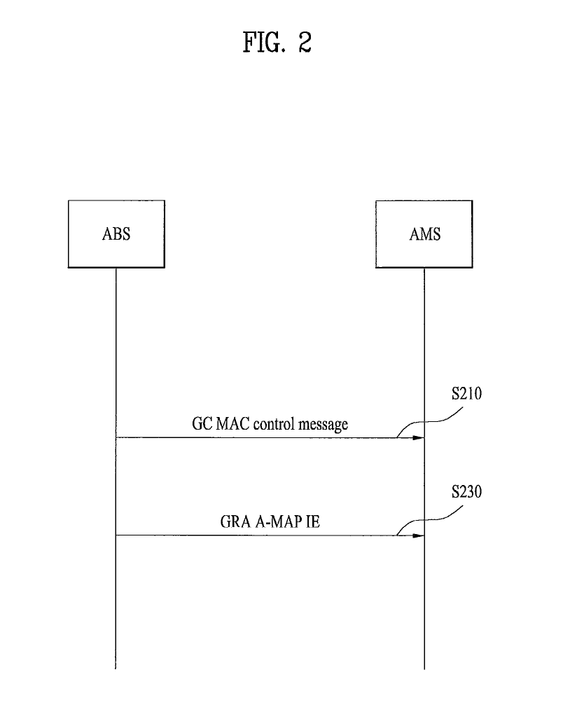

FIG. 2 is a diagram illustrating an example of a group resource allocation method.

Group control information is used to configure and allocate resources for one or more users (or user equipments) within one user group. Two types of operations are required for group scheduling.

The base station may perform an operation for allocating one user to one group. In order to add one user to one group in a downlink or uplink, the base station transmits group configuration MAC management message, group configuration A-MAP information element (IE) or group configuration MAC control message to the user equipment (S210).

Also, the base station may allocate resources to users within one group. In order to allocate resources to one or more users within one group, the base station transmits downlink/uplink group resource allocation (GRA) A-MAP IE to the user equipment (S230).

At the step S230, the downlink/uplink group resource allocation (GRA) A-MAP IE is included in user-specific resource assignment information in an A-MAP region. The group resource allocation A-MAP IE includes a bitmap representing scheduled users or signaling resource allocation, modulation and coding scheme (MCS) and/or resource size.

The following Table 1 illustrates an example of a group resource allocation (GRA) A-MAP IE format used at the step S230.

TABLE 1

| Syntax | Size | Contents |
|---|---|---|
| Group Resource | — | — |
| Allocation A-MAP IE | | |
| ( ) { | | |
| A-MAP IE Type | 4 | Indication of group resource |
| | | allocation A-MAP IE |
| User Bitmap | variable | Bitmap for indicating scheduled |
| | | AMS in a corresponding group. It |
| | | has the same size as the user |
| | | bitmap size allocated to each |
| | | user equipment in a group |
| | | configuration MAC control |
| | | message. |
| | | 0: AMS is not allocated to the |
| | | current AAI subframe. |
| | | 1: AMS is allocated to the |
| | | current AAI subframe. |
| Resource offset | 7 | Indication of start LRU for |
| | | resource allocation for a |
| | | corresponding group |
| HFA offset | 6 | Indication of start of HARQ |
| | | feedback index for HFA channel |
| | | allocation for scheduled user |
| | | equipments. |
| NDA | [2] [3] | |
| For (i=0, i++, | | |
| i<NDA) { | | |
| User Bitmap Index | 5 | Indication of user bitmap index |
| | | of deleted AMS. |
| HFA | 6 | Indication of HARQ feedback |
| | | allocation for deleted AMS. |
| } | | |
| — | — | — |

In Table 1, the A-MAP type field represents that the corresponding MAP information element is the A-MAP IE for group resource allocation, and the user bitmap field represents a bitmap for indicating scheduled AMS in the corresponding group. Also, the user bitmap field has the same size as that of the user bitmap allocated from the group configuration MAC control message to each user equipment. The resource offset field indicates a start LRU of a resource allocated to the corresponding group, and an HARQ feedback allocation (HFA) offset field represents start of an HARQ feedback index used for scheduled allocation. The NDA field represents the number of AMSs deleted from the corresponding group, and the user bitmap index field indicates a user bitmap index of the deleted AMS. The HFA field indicates HARQ feedback allocation for the deleted AMS.

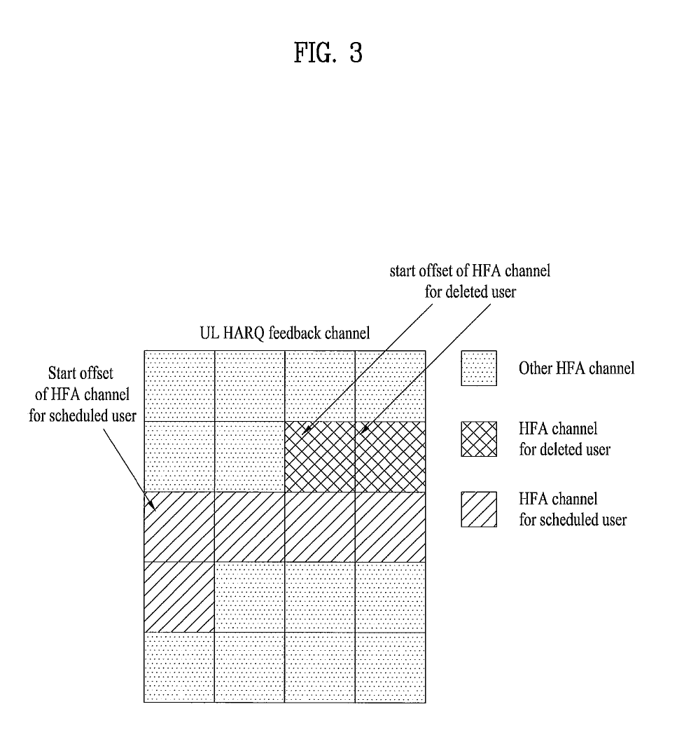

FIG. 3 is a diagram illustrating an example of an HARQ feedback channel allocated to user equipments deleted from a group. In FIG. 3, the HARQ feedback channel represents allocation figure of a feedback channel based on the HFA and the user bitmap index included in the GRA A-MAP information element of FIG. 2.

### First Embodiment

In order to reduce unnecessary overhead in a group resource allocation map (e.g., GRA A-MAP IE), the user equipments (i.e., scheduled user equipments or deleted user equipments) indicated by the GRA A-MAP IE share a start point (e.g., HFA offset) of the HFA. For example, if there is any user equipment deleted from the corresponding group and the base station transmits the GRA A-MAP IE, which includes information on one HFA offset, to the user equipment, the user equipment may acquire information of the deleted user equipments and the scheduled user equipments. Also, the user equipment may know whether to use HFA at which location from the HFA offset on the basis of the GRA A-MAP IE.

The following Table 2 illustrates an example of a GRA A-MAP IE format used in the embodiments of the present invention.

TABLE 2

| Syntax | Size | Contents |
|---|---|---|
| Group Resource | | |
| Allocation A-MAP IE | | |
| ( ) { | | |
| A-MAP IE Type | 4 | Group resource allocation A-MAP |
| | | IE |
| HFA offset | 4 | Indication of start of HARQ |
| | | feedback index allocated to |
| | | deleted user equipment and |
| | | scheduled user equipment in a |
| | | corresponding group at a current |
| | | frame. |
| NDA | 2 | Indication of the number of AMSs |
| | | deleted from a corresponding |
| | | group. |
| For(i=0, i++, | | |
| i<NDA){ | | |
| User Bitmap Index | 5 | Indication of user bitmap index |
| | | of deleted AMS. |
| } | | |
| User Bitmap size | 2 | Indication of length of user |
| | | bitmap. |
| | | 0b00: 0, |
| | | 0b01: 4, |
| | | 0b10: 8, |
| | | 0b11: 16 |
| | | If there is no scheduled user, |
| | | the user bitmap size is set to |
| | | 0. |
| If (User Bitmap | | |
| Size ! = 0) { | | |
| Resource offset | [6] [8] | Indication of start LRU for |
| | | resource allocation for a |
| | | corresponding group |
| User Bitmap | variable | User bitmap for indicating |
| | | scheduled AMS in a corresponding |
| | | group. The user bitmap size is |
| | | the same as that indicated by a |
| | | user bitmap size field. |
| — | — | — |
| } | | |
| Padding | Variable | Padding bit for adjusting byte |
| | | size |
| MCRC | [16] | CRC masked 16 bits |

In Table 2, the A-MAP IE type field represents that the corresponding MAP information element is the A-MAP IE for group resource allocation, and the HARQ feedback allocation (HFA) offset field indicates a start channel of an HARQ ACK feedback channel allocated to user equipments deleted from the corresponding group and/or user equipments scheduled from the corresponding group at the current frame. In other words, the HFA offset field indicates a start ACK channel of the HARQ feedback channel allocated to the deleted user equipments as well as the scheduled user equipments. Accordingly, the HARQ ACK channels allocated to the deleted user equipments and the scheduled user equipments are sequentially allocated in the order of ACK channel indicated by the HFA offset field.

The NDA field represents the number of AMSs deleted from the corresponding group, and the user bitmap index field indicates a user bitmap index of the deleted AMS. Here, the user bitmap index field is included in the GRA A-MAP IE as much as the number of the deleted user equipments. Accordingly, if there are a number of user equipments deleted from the corresponding group, the size of the GRA A-MAP IE may be increased.

The user bitmap size field indicates the length of the user bitmap. Also, the resource offset field indicates a start LRU of a resource allocated to the corresponding group, and the user bitmap field is used to indicate AMS scheduled from the corresponding group. The A-MAP IE field of Table 2 may be transmitted at the step S230 of FIG. 2.

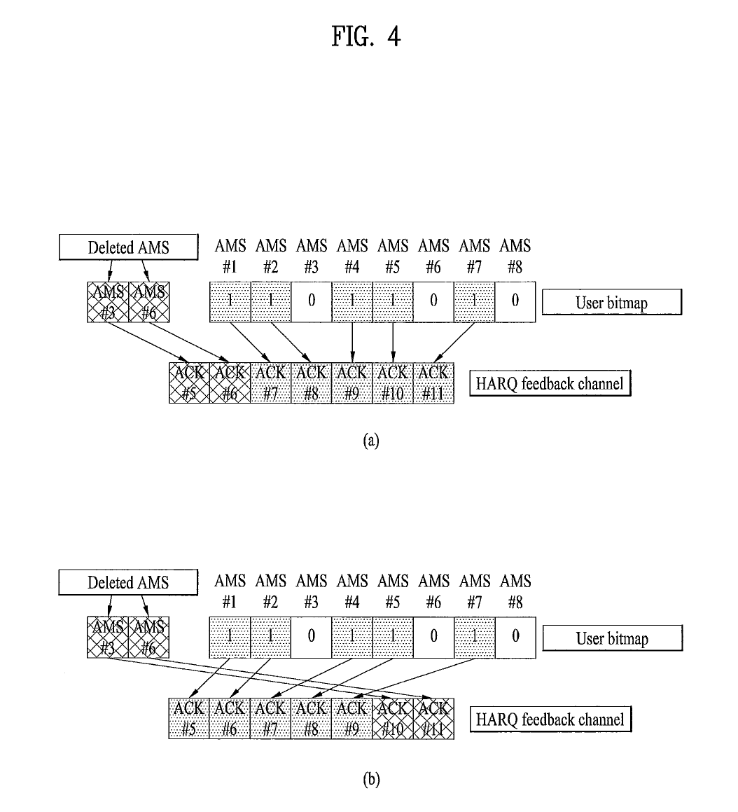

FIG. 4 is a diagram illustrating a mapping relation between a user bitmap based on A-MAP IE field of Table 2 and an HARQ feedback channel.

In FIG. 4(a) and FIG. 4(b), the user bitmap represents user equipments AMS #1 to AMS #8 scheduled from eight corresponding groups. In other words, if the user bitmap is set to ‘1’, it represents that the user equipment is scheduled from the corresponding group, and if the user bitmap is set to ‘0’, it represents that the user equipment is deleted from the corresponding group or not scheduled at the corresponding frame although not deleted.

Here, it is assumed that the HFA offset included in the A-MAP IE indicates 5, the number of deleted user equipments (AMS) is 2 (NDA=2), and the number of scheduled user equipments is 5. Accordingly, in FIG. 4(a) and FIG. 4(b), the first deleted user equipment (AMS #3) uses the fifth HFA channel (ACK #5), the second deleted user equipment (AMS #6) uses the sixth HFA channel (ACK #6), the first scheduled user equipment (AMS #1) uses the seventh HFA channel (ACK #7), the second scheduled user equipment (AMS #2) uses the eighth HFA channel (ACK #8), the third scheduled user equipment (AMS #4) uses the ninth HFA channel (ACK #9), the fourth scheduled user equipment (AMS #5) uses the tenth HFA channel (ACK #10), and the fifth scheduled user equipment (AMS #7) uses the eleventh HFA channel (ACK #11).

In other words, the ACK channels for the deleted user equipments and the ACK cannels for the scheduled user equipments are allocated sequentially in the order of the ACK channel indicated by the HFA offset. FIG. 4(a) illustrates that the ACK channels for the deleted user equipments are first allocated, and FIG. 4(b) illustrates that the ACK channels for the scheduled user equipments are first allocated.

### Second Embodiment

According to another embodiment of the present invention, user equipments deleted from the GRA A-MAP IE may be notified in a bitmap type instead of an index type (e.g., user bitmap index) to reduce overhead. In other words, according to another embodiment of the present invention, a deletion bitmap is used.

The following Table 3 illustrates an example of a GRA A-MAP IE format that includes a deletion bitmap.

TABLE 3

| Syntax | Size | Contents |
|---|---|---|
| A-MAP IE Type | 4 | Group resource allocation A-MAP |
| | | IE |
| HFA offset | 4 | Indication of start of HARQ |
| | | feedback index allocated to |
| | | deleted user equipment and |
| | | scheduled user equipment in a |
| | | corresponding group at a current |
| | | frame. |
| — | — | — |
| User Bitmap size | 2 | Indication of length of user |
| | | bitmap. |
| | | 0b00: 0, |
| | | 0b01: 4, |
| | | 0b10: 8, |
| | | 0b11: 16 |
| | | If there is no scheduled user, |
| | | the user bitmap size is set to |
| | | 0. |
| If (User Bitmap | — | — |
| Size ! = 0) { | | |
| Resource offset | [6] [8] | Indication of start LRU for |
| | | resource allocation for a |
| | | corresponding group |
| User Bitmap | variable | User bitmap for indicating |
| | | scheduled AMS in a corresponding |
| | | group. The user bitmap size is |
| | | the same as that indicated by a |
| | | user bitmap size field. |
| Deletion Bitmap | Variable | Indication of user equipments |
| | | deleted from a corresponding |
| | | group. |
| — | — | — |
| } | | |
| Padding | Variable | Padding bit for adjusting byte |
| | | size |
| MCRC | [16] | CRC masked 16 bits |

In Table 3, the A-MAP IE type field represents that the corresponding MAP information element is the A-MAP IE for group resource allocation, and the HARQ feedback allocation (HFA) offset field indicates a start channel of an HARQ ACK feedback channel allocated to user equipments deleted from the corresponding group and/or user equipments scheduled from the corresponding group at the current frame. In other words, the HFA offset field indicates a start ACK channel of the HARQ feedback channel allocated to the deleted user equipments as well as the scheduled user equipments. Accordingly, the HARQ ACK channels allocated to the deleted user equipments and the scheduled user equipments are allocated in the order of ACK channel indicated by the HFA offset field.

The user bitmap size field indicates the length of the user bitmap. Also, the resource offset field indicates a start LRU of a resource allocated to the corresponding group, and the user bitmap field is used to indicate AMS scheduled from the corresponding group. The deletion bitmap is configured as much as the number of scheduled user equipments and the number of deleted user equipments, wherein each bit represents which user equipment is deleted.

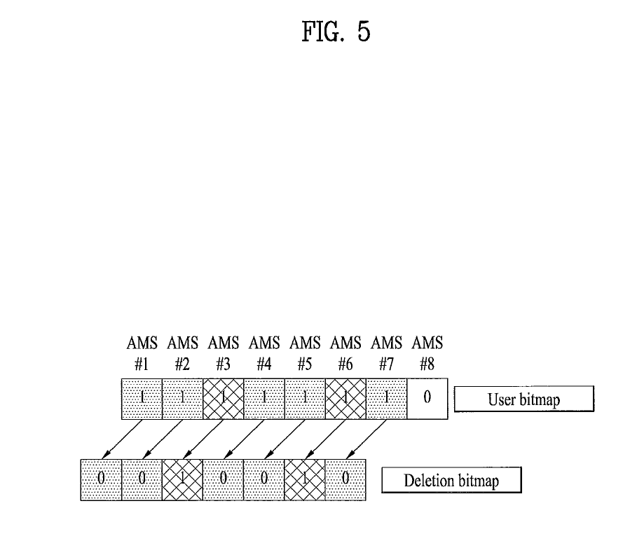

FIG. 5 is a diagram illustrating a method of using a deletion bitmap.

Referring to FIG. 5, eight user equipments AMS #1 to AMS #8 are allocated to one group. In the user bitmap, ‘1’ represents the scheduled user equipment or the deleted user equipment, and ‘0’ represents the user equipment which is not scheduled. The deletion bitmap is configured as much as the number of scheduled user equipments and the number of deleted user equipments, and ‘0’ indicates the scheduled user equipments and ‘1’ indicates the deleted user equipments. In FIG. 5, the third user equipment and the sixth user equipment are deleted, and are represented by ‘1’ in the deletion bitmap mapped with the user bitmap.

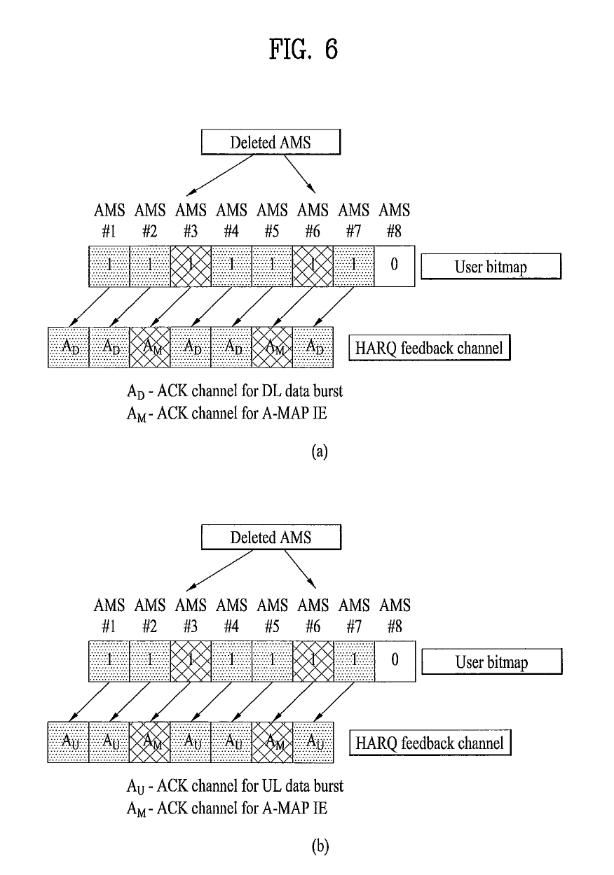

FIG. 6 is a diagram illustrating a method for allocating an uplink ACK channel and a downlink ACK channel by using a deletion bitmap.

FIG. 6(a) illustrates that a HARQ feedback channel for downlink data burst is allocated, and FIG. 6(b) illustrates that a HARQ feedback channel for uplink data burst is allocated. Here, scheduled and deleted user equipments in FIG. 6 will be understood with reference to FIG. 5.

In FIG. 6(a), the deleted user equipments are the third user equipment (AMS #3) and the sixth user equipment (AMS #6). The HARQ feedback allocation (HFA) channel for the scheduled user equipments may be allocated to the ACK channel for downlink data burst, and the HARQ feedback channel for the deleted user equipments may be allocated to the ACK channel for the A-MAP IE.

The A-MAP used in FIG. 6(b) is the UL GRA A-MAP for uplink group resource allocation. In this case, since ACK for data burst is ACK for uplink data burst, the base station transmits the ACK to the user equipment as the DL HARQ feedback channel. Also, the base station does not need to transmit the ACK for the A-MAP IE. In this case, the ACK channel for the A-MAP IE is allocated to the deleted user equipment only. Accordingly, if the ACK channel is allocated to all the scheduled user equipments, a problem occurs in that waste of unnecessary HFA may occur.

In order to solve the problem, the scheduled user equipments AMSs and the deleted user equipments AMSs described in the embodiment 1 may share HFA offset, and a method for sequentially allocating HFA to each group may be used. In this case, waste of unnecessary HFA allocation may be avoided in the uplink.

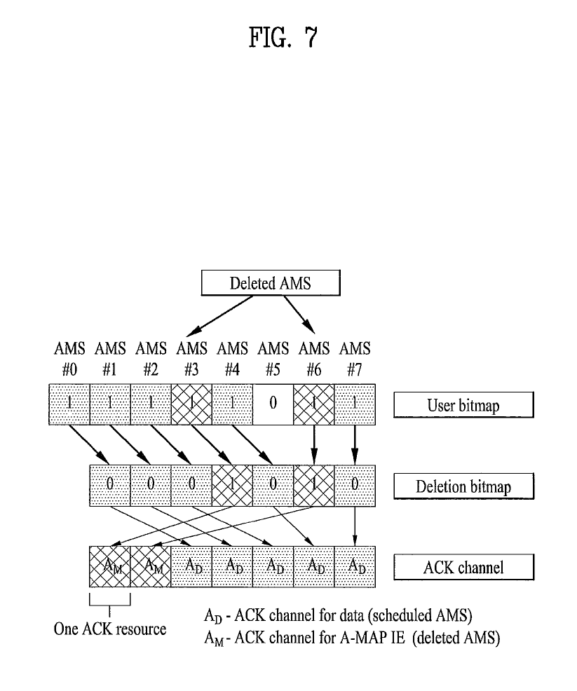

FIG. 7 is a diagram illustrating an example of a method for allocating downlink group resources based on a deletion bitmap in accordance with one embodiment of the present invention.

The base station may allocate HARQ feedback channel to the user equipments included in a specific group by using the GRA A-MAP IE described in Table 3. If eight user equipments AMS #1 to AMS #8 are included in a specific group in FIG. 7, it is assumed that the fourth user equipment and the seventh user equipment are the deleted user equipments and the sixth user equipment is not scheduled at the corresponding frame.

Here, the user bitmap is set to ‘1’ if each user equipment is scheduled or deleted at the corresponding frame and is set to ‘0’ if each user equipment is not scheduled. Also, the deletion bitmap represents the scheduled user equipment as ‘0’ and the deleted user equipment as ‘1’.

Here, the order of allocation of the HARQ feedback allocation (HFA) channels allocated to each user equipment is performed in such a manner that the ACK channel for the deleted user equipments is first allocated and the ACK channel for the scheduled user equipments is then allocated. The order of allocation of the HFA channels may be performed in such a manner that the ACK channel for the scheduled user equipments is first allocated in accordance with requirements of the user and the ACK channel for the deleted user equipments is then allocated. The ACK channels allocated to the deleted user equipment and the scheduled user equipment in FIG. 7 are allocated starting from the ACK channel indicated by the HFA offset field.

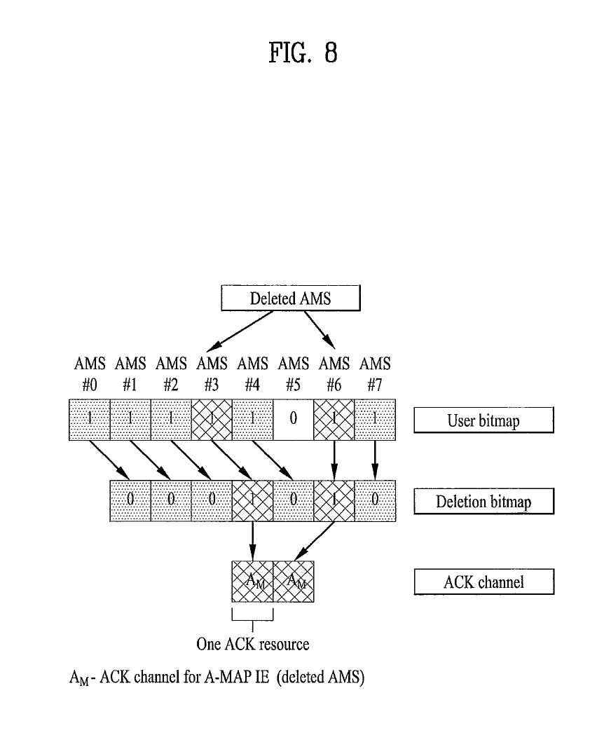

FIG. 8 is a diagram illustrating an example of a method for allocating uplink group resources based on a deletion bitmap in accordance with another embodiment of the present invention.

The base station may allocate HARQ feedback channel to the user equipments included in a specific group by using the GRA A-MAP IE described in Table 3. If eight user equipments AMS #1 to AMS #8 are included in a specific group in FIG. 8, it is assumed that the fourth user equipment and the seventh user equipment are the deleted user equipments and the sixth user equipment is not scheduled at the corresponding frame.

Here, the user bitmap is set to ‘1’ if each user equipment is scheduled or deleted at the corresponding frame and is set to ‘0’ if each user equipment is not scheduled. Also, the deletion bitmap represents the scheduled user equipment as ‘0’ and the deleted user equipment as ‘1’.

In FIG. 8, since the scheduled user equipments do not transmit the ACK in the uplink, the base station may reduce waste of the ACK channel by sequentially allocating the HFA to the deleted user equipments only. Also, in FIG. 8, the ACK channels are allocated to the deleted user equipments by starting from the ACK channel indicated by the HFA offset field.

### Third Embodiment

In case of GRA, the base station may efficiently allocate a channel quality indicator (CQI) channel. Generally, user equipments having similar MCS are grouped in one group, and an effective range of CQI may be different as all the user equipments do not cover the entire MCS regions.

In the IEEE 802.16m system, the base station transmits one of CQI indexes of a total of 6 bits, which include a total of four space time code (STC) rates and 16 MCSs, to the user equipment, wherein the transmitted one CQI index is suitable for the current status of the user equipment. Since it is general that deviation of the CQI index values is not great in one group, the smaller CQI index may be used.

For example, if the user equipment uses the STC rate of 1 bit and the MCS of 3 bits only, the base station may transmit CQI index of 4 bits. If the user equipment uses static STC rate only, the base station may transmit the MCS of 3 bits.

In particular, it is likely that GRA may be used for VoIP, and the base station may sufficiently transmit the MCS of 3 bits as it supports a limited MIMO mode. If the base station and the GRA user equipment use a CQI transport channel that covers 6 bits, they may use two divided CQI channels. Also, if the MCS is represented by 2 bits, the corresponding CQI channel may be divided into three. In other words, if VoIP users are increased, the number of channels for CQI transmission is insufficient. Even in this case, the size of the MCS may be adjusted for efficient CQI transmission. In configuration of GRA, the base station notifies the user equipment of the CQI range, and the user equipment has only to report CQI within this CQI range.

The following Table 4 illustrates an example of a GRA configuration MAC control message format if 2 bits or 6 bits are used for CQI.

TABLE 4

| Syntax | Size | Contents |
|---|---|---|
| Group Configuration | | |
| Message | | |
| Type | 8 | Group configuration MAC control |
| | | message |
| Group ID | 5 | Indication of group index |
| MCS set ID | 3 | Indication of MCS set supported |
| | | by a group selected from |
| | | predetermined MCS candidate |
| | | sets. The MCS candidate sets are |
| | | transmitted through an |
| | | additional broadcast message. |
| CQI Type | 1 | 0b0: 6 bits |
| | | 0b1: 2 bits |
| PFFBCH number | 4 | Primary PFFBCH channel |
| | | allocation (CQI report channel) |
| If (CQI_Type = 0b1) | | |
| { | | |
| Lowest CQI | 4 | Minimum CQI(or MCS) for a |
| | | corresponding group |
| } | | |
| HARQ Burst Size Set | [2] | |
| ID | | |
| GRA Period | [2] | |
| Group MIMO Mode | 2 | |
| User Bitmap Index | [5] | Indication of user bitmap index |
| | | for AMS. AMS may have a |
| | | plurality of user bitmap indexes |
| | | from one group. |
| Initial ACID | TBD | Indication of initial ACID of |
| | | ACIDs used for group resource |
| | | allocation |
| N_ACID | TBD | Indication of the number of |
| | | ACIDs used for group resource |
| | | allocation. |
| Padding | Variable | Padding bit for byte alignment. |

Referring to Table 4, the type field represents that the corresponding message is a group configuration MAC control message, and group ID indicates index of a group in which the corresponding user equipment is included, and MCS set ID indicates MCS set supported by a corresponding group, among predetermined MCS candidate sets.

The CQI type field represents whether the corresponding CQI channel uses 2 bits or 6 bits. A primary fast feedback channel (FFBCH) number field represents primary FFBCH channel allocation, and a lowest CQI field represents a minimum CQI value used in a corresponding group in accordance with the CQI type.

The user bitmap index indicates a user bitmap index for the AMS. Here, the AMS may have a plurality of user bitmap indexes in the corresponding group. The initial ACID field indicates initial ACID of ACIDs used for group resource allocation, and N ACID field represents the number of ACIDs used for group resource allocation.

In Table 4, if the group, which includes AMS, supports only MCS Nos. 3 to 6 among a total of 16 MCSs, the base station allocates 2 bits to the CQI channel. Accordingly, the base station has only to allocate the MCS No. 3 to the lowest CQI. For example, since the MCS Nos. 3 to 6 exist, the base station allocates the MCS No. 3 to the minimum CQI number (00) and allocates the MCS No. 6 to the maximum CQI number (11).

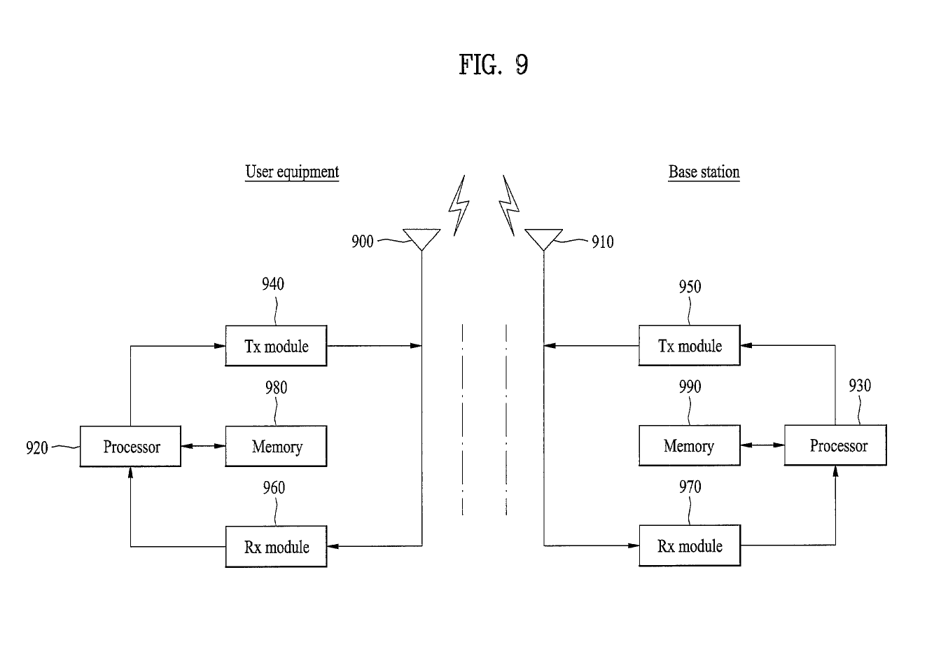

FIG. 9 is a block diagram illustrating a user equipment and a base station through which the embodiments of the present invention described in FIG. 1 to FIG. 8 can be carried out, in accordance with another embodiment of the present invention.

The user equipment may be operated as a transmitter in an uplink, whereas the user equipment may be operated as a receiver in a downlink. Also, the base station may be operated as a receiver in the uplink, whereas the base station may be operated as a transmitter in the downlink.

In other words, each of the user equipment and the base station may include a transmission (Tx) module 940, 950 and a reception (Rx) module 950, 970 for transmitting and receiving information, data and/or message. Each of the user equipment and the base station may include an antenna 900, 910 for transmitting and receiving information, data and/or message. Also, each of the user equipment and the base station may include a processor 920, 930 for performing the aforementioned embodiments of the present invention, and a memory 980, 990 for storing temporarily or persistently a processing procedure of the processor.

In particular, the processor 920, 930 may further include a function module for performing the group resource allocation method disclosed in the embodiments of the present invention. Also, the user equipment and the base station of FIG. 9 may further include a low power radio frequency (RF)/intermediate frequency (IF) module.

The Tx module and the Rx module included in the user equipment and the base station may perform packet modulation and demodulation function for data transmission, quick packet channel coding function, orthogonal frequency division multiple access (OFDMA) packet scheduling, time division duplex (TDD) packet scheduling and/or channel multiplexing function.

The apparatuses described in FIG. 9 are the means through which the methods described in FIG. 1 to FIG. 8 may be carried out. The embodiments of the present invention may be performed using the elements and functions of the aforementioned user equipment and the base station.

The processor of the user equipment may receive the messages described in FIG. 2 by controlling the Rx module (S210, S230). Also, the processor of the user equipment may configure a user bitmap, a deletion bitmap and/or a group resource allocation bitmap by using the fields included in the received GRA A-MAP IE.

Also, the processor of the base station may group the user equipments in the cell region managed by itself. Here, the processor may allocate group resources to the grouped user equipment, and may transmit GRA A-MAP IE and GRA MAC control message described in Table 2 to Table 4 to the user equipment to provide information on the group resources.

In the mean time, in the present invention, examples of the user equipment may include a personal digital assistant (PDA), a cellular phone, a personal communication service (PCS) phone, a global system for mobile (GSM) phone, a wideband CDMA (WCDMA) phone, a mobile broadband system (MBS) phone, a hand-held PC, a notebook PC, a smart phone, and a multi mode-multi band (MM-MB) terminal.

In this case, the smart phone is a terminal provided with advantages of a mobile communication terminal and a personal digital assistant (PDA). The smart phone may mean a terminal in which a schedule management function of the PDA and data communication functions of facsimile transmission/reception, internet access, etc. are integrated on a mobile communication terminal. Also, the multimode-multiband terminal means a terminal having a built-in multi-MODEM chip to be operable in a portable internet system and other mobile communication systems (e.g., CDMA (code division multiple access) 2000 system, WCDMA (wideband CDMA) system, etc.).

The embodiments according to the present invention may be implemented by various means, for example, hardware, firmware, software, or their combination.

If the embodiment according to the present invention is implemented by hardware, the embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the method according to the embodiments of the present invention may be implemented by a type of a module, a procedure, or a function, which performs functions or operations described as above. For example, a software code may be stored in the memory unit 980, 990 and then may be driven by the processor 920, 930. The memory unit may be located inside or outside the processor to transmit and receive data to and from the processor through various means which are well known.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. It is also obvious to those skilled in the art that claims that are not explicitly cited in each other in the appended claims may be presented in combination as an embodiment of the present invention or included as a new claim by a subsequent amendment after the application is filed.

### INDUSTRIAL APPLICABILITY

The embodiments of the present invention may be applied to various wireless access systems. Examples of the various wireless access systems include 3GPP (3rd Generation Partnership Project), 3GPP2 and/or IEEE 802.xx (Institute of Electrical and Electronic Engineers 802) system. The embodiments of the present invention may be applied to all the technical fields based on the various wireless access systems, as well as the various wireless access systems.

1. A method for allocating an HARQ feedback allocation (HFA) channel in group resource allocation, the method comprising the steps of:
receiving a group resource allocation A-MAP information element (GRA A-MAP IE) from a base station, the group resource allocation A-MAP information element including an HFA offset field for indicating the start of the HFA channel used for user equipments that are scheduled and deleted, a number (NDA) field for denoting the number of the deleted user equipments, and a user bitmap field for indicating the scheduled user equipments; and
transmitting and receiving an acknowledgement message through the HARQ feedback channel that is acquired by using the HFA offset field, the number field and the user bitmap field.

2. The method according to claim 1, wherein the group resource allocation A-MAP information element further includes a user bitmap index field indicating a user bitmap index for each of the deleted user equipments.

3. The method according to claim 1, wherein the group resource allocation A-MAP information element further includes a deletion bitmap field indicating the deleted user equipments.

4. The method according to claim 1, wherein the HARQ feedback channel is allocated in the order of the acknowledgement channel indicated by the HFA offset field, the acknowledgement channel for the deleted user equipments, and the acknowledgement channel for the scheduled user equipments.

5. A method for allocating an HARQ feedback allocation (HFA) channel in group resource allocation, the method comprising the steps of:
transmitting a group resource allocation A-MAP information element (GRA A-MAP IE) at a base station, the group resource allocation A-MAP information element including an HFA offset field for indicating the start of the HFA channel used for user equipments that are scheduled and deleted, a number (NDA) field for denoting the number of the deleted user equipments, and a user bitmap field for indicating the scheduled user equipments; and
transmitting and receiving an acknowledgement message through the HARQ feedback channel indicated by the HFA offset field, the number field and the user bitmap field.

6. The method according to claim 5, wherein the group resource allocation A-MAP information element further includes a user bitmap index field indicating a user bitmap index for each of the deleted user equipments.

7. The method according to claim 5, wherein the group resource allocation A-MAP information element further includes a deletion bitmap field indicating the deleted user equipments.

8. The method according to claim 5, wherein the HARQ feedback channel is allocated in the order of the acknowledgement channel indicated by the HFA offset field, the acknowledgement channel for the deleted user equipments, and the acknowledgement channel for the scheduled user equipments.

9. A user equipment allocated with an HARQ feedback allocation (HFA) channel in group resource allocation, the user equipment comprising:
a transmission (Tx) module for transmitting a radio signal;
a reception (Rx) module for receiving the radio signal; and
a processor supporting functions related to the group resource allocation,
wherein the user equipment receives a group resource allocation A-MAP information element (GRA A-MAP IE) from a base station, the group resource allocation A-MAP information element including an HFA offset field for indicating the start of the HFA channel used for user equipments that are scheduled and deleted, a number (NDA) field for denoting the number of the deleted user equipments, and a user bitmap field for indicating the scheduled user equipments,
the processor acquires the HARQ feedback channel for group resource allocation to which the user equipment belongs, by using the HFA offset field, the number field and the user bitmap field, and
the user equipment transmits an acknowledgment message to the base station by using the Tx module.

10. The user equipment according to claim 9, wherein the group resource allocation A-MAP information element further includes a user bitmap index field indicating a user bitmap index for each of the deleted user equipments.

11. The user equipment according to claim 9, wherein the group resource allocation A-MAP information element further includes a deletion bitmap field indicating the deleted user equipments.

12. The user equipment according to claim 9, wherein the HARQ feedback channel is allocated in the order of the acknowledgement channel indicated by the HFA offset field, the acknowledgement channel for the deleted user equipments, and the acknowledgement channel for the scheduled user equipments.

13. A base station allocating an HARQ feedback allocation (HFA) channel in group resource allocation, the base station comprising:
a transmission (Tx) module for transmitting a radio signal;
a reception (Rx) module for receiving the radio signal; and
a processor supporting functions related to the group resource allocation,
wherein the base station transmits a group resource allocation A-MAP information element (GRA A-MAP IE) through the Tx module, the group resource allocation A-MAP information element including an HFA offset field for indicating the start of the HFA channel used for user equipments that are scheduled and deleted, a number (NDA) field for denoting the number of the deleted user equipments, and a user bitmap field for indicating the scheduled user equipments, and
the base station receives an acknowledgement message through the HARQ feedback channel indicated by the HFA offset field, the number field and the user bitmap field through the Tx module.

14. The base station according to claim 13, wherein the group resource allocation A-MAP information element further includes a user bitmap index field indicating a user bitmap index for each of the deleted user equipments.

15. The base station according to claim 13, wherein the group resource allocation A-MAP information element further includes a deletion bitmap field indicating the deleted user equipments.

16. The base station according to claim 13, wherein the HARQ feedback channel is allocated in the order of the acknowledgement channel indicated by the HFA offset field, the acknowledgement channel for the deleted user equipments, and the acknowledgement channel for the scheduled user equipments.
